(19) United States
(12) Patent Application Publication
(10) Pub. No.: US 2016/0224750 A1
(43) Pub. Date: Aug. 4, 2016

(54) MONITORING SYSTEM FOR ASSESSING CONTROL OF A DISEASE STATE

(71) Applicant: The Board of Trustees of The Leland Stanford Junior University, Palo Alto, CA (US)

(72) Inventors: William Christopher Kethman, Palo Alto, CA (US); Bronwyn Uber Harris, Redwood City, CA (US); Frank Tinghwa Wang, Cupertino, CA (US); Todd Edward Murphy, Sunnyvale, CA (US)

(21) Appl. No.: 15/010,488

(22) Filed: Jan. 29, 2016

Related U.S. Application Data
(60) Provisional application No. 62/110,490, filed on Jan. 31, 2015.

(51) Int. Cl. G06F 19/00

(52) U.S. Cl. CPC G06F 19/3406

(57) ABSTRACT

A method for assessing the state of the condition of asthma in a patient may involve sensing individual patient data using one or more sensors on or near the patient, transmitting the individual patient data to a processor, comparing, with the processor, the individual patient data with baseline patient data related to the patient and/or population data related to a patient population comparable to the patient, to provide comparison data, and providing an assessment of the current state of the patient's asthma condition, based on the comparison data. In some embodiments, the individual patient data is related to at least one physiological parameter of the patient, and at least one of the sensors is a passive sensor that does not require the patient to apply it or activate it.

### CROSS-REFERENCE TO RELATED APPLICATION

This application claims priority to U.S. Provisional Application Ser. No. 62/110,490, filed Jan. 31, 2015 and entitled “MONITORING SYSTEM FOR EARLY DETECTION OF CHANGES IN DISEASE STATE,” the entirety of which is herein incorporated by reference.

### TECHNICAL FIELD

This application is related to noninvasive, diagnostic, medical devices, systems and methods. More specifically, this application is related to methods for monitoring and managing chronic medical conditions.

### BACKGROUND

Management of chronic diseases is a large and costly problem in the United States accounting for over 80% of the nation's health care costs and for 7 out of every 10 deaths.

Asthma is one example of a chronic disease that takes a significant toll on individual patients and the healthcare system as a whole. Asthma is a chronic inflammatory disease of the airways, characterized by variable and recurring symptoms. Periods of acute worsening in symptoms, known as exacerbations, are a major feature of the disease. Approximately 300 million individuals worldwide are affected by asthma, and in the United States there are approximately 23 million individuals with asthma, resulting in 1.7 million emergency department visits each year and 10.1 million lost workdays.

Asthma is one of the most common chronic diseases in children, affecting 7.1 million children in the United States alone. If not managed properly, it can be life threatening, with over 3,000 deaths in the United States due to asthma under the age of 15 years old in 2011. Apart from being life threatening, asthma also has a significant impact on morbidity and quality of life in children and their families. Asthma is the leading cause of school absenteeism. In 2008, for example, an estimated 14 million lost school days were attributed to asthma, and children with persistent asthma have been shown to perform lower on standardized testing.

Asthma is costly to the healthcare system, totaling an estimated $56 billion dollars in annual healthcare expenditures in the United States alone. A disproportionate amount of this spending can be attributed to poor disease control. According to Aetna, a major health insurance provider, an emergency department visit for a pediatric asthmatic patient can cost the insurer $600 and a hospitalization can cost $6,600. A person's asthma can be classified in various ways. Using one common classification scheme, there are 2.9 million children in the United States with moderate to severe persistent asthma. A patient with moderate asthma has a 3% chance of being hospitalized and an 11% chance of going to the emergency department in a three-month period. A patient with severe asthma has a 10% chance of being hospitalized and a 21% chance of going to the emergency department in a three-month period.

Some treatments and management strategies currently exist for asthma. For example, written asthma action plans have been demonstrated to be a relatively effective tool for some patients in improving control over asthma symptoms. Use of these tools is becoming more frequent, and increasing the proportion of persons with asthma who use these plans is part of the U.S. Department of Health and Human Services' Healthy People 2020 goals. Typically, these written plans help individuals and families self-manage their illness by guiding their use of various environmental modifications or medical treatments available (e.g., inhalers, oral steroids) and when to contact their healthcare providers. These action plans, however, use relatively subjective criteria to define exacerbations, and many of the signs, such as tachypnea (abnormally rapid breathing) and nighttime cough frequency, are late findings and/or are difficult to measure. Some asthmatics also use peak flow meters—small devices into which the patient blows in order to measure lung function. Although the meters provide quantitative and objective measurements, they are effort dependent and require longitudinal daily measurements and as a result are highly variable, particularly in children.

Another tool to help manage asthma, in particular to assess the control of the patient's asthma and adjust controller medications accordingly, is the asthma control test. Similar to the asthma action plan, however, the asthma control test relies on the families of asthma patients to assess and report symptoms accurately and routinely.

A number of technologies have been developed in an attempt to allow asthma patients to better monitor their disease outside the hospital. These technologies are mainly targeted at improving adherence to therapy or detection of exacerbations. One challenge of some of these technologies, however, is that they use relatively late indicators of worsening disease status that limit their ability to improve the effectiveness of short-term and long-term disease management. Other technologies focus on trying to reduce exacerbation events, which represents only a small component of what it means to have control over a disease. These technologies do not provide insights into long-term control and are not developed as a management tool for clinicians that would inform pharmacologic therapy choices and other interventions designed to improve long-term control.

Therefore, a substantial gap remains in the ability to reliably measure and monitor asthmatic status outside of healthcare facilities. It would thus be desirable to have a system and method for monitoring asthma status outside the hospital, which would empower families and healthcare providers to more effectively manage the disease. Ideally, such a system and method would help provide improved disease monitoring and management, relative to currently available systems and methods. Also ideally, the system and method might be used for monitoring other disease states, such as allergies, chronic obstructive pulmonary disease, diabetes, hypertension, autoimmune disorders, migraine or other neurologic disease, obstructive sleep apnea, cystic fibrosis, arthritis and other rheumatologic conditions, seizure disorders, cardiovascular disease, peripheral vascular disease and/or congestive heart failure. The embodiments described below attempt to achieve at least some of these objectives.

### BRIEF SUMMARY

This application describes monitoring systems and methods for assessing control of a disease state, so that a patient, healthcare provider, family member of the patient and/or other users can improve control of the disease state. In one embodiment, the system and method may be used to assess control of asthma in a patient. For example, the system and method may be used to sense the onset of an asthma exacerbation in a patient and provide information to the patient and/or one or more other people, to help manage the patient's asthma. The system and method will generally involve measuring at least one parameter, and often multiple parameters, with one or more sensors located near to the patient and/or one or more sensors located more remotely. Examples of parameters include, but are not limited to, individual, non-individual, local, regional, and/or geographic parameters, physiologic parameters, local environmental parameters, and global environmental factors. Data are then analyzed to provide a personalized assessment of control of a disease state, such as asthma, which can then be used by patients, their families and/or healthcare professionals, to improve clinical outcomes.

In one aspect, a method for assessing the state of the condition of asthma in a patient may involve: sensing individual patient data using one or more sensors on or near the patient; transmitting the individual patient data to a processor; comparing, with the processor, the individual patient data with at least one of baseline patient data related to the patient or population data related to a patient population comparable to the patient, to provide comparison data; and providing an assessment of the current state of the patient's asthma condition, based on the comparison data. The individual patient data may be related to at least one physiological parameter of the patient, and at least one of the sensors may be a passive sensor that does not require the patient to apply it or activate it.

In some embodiments, the method may further involve analyzing, by a service provider, the individual data, the comparison data and/or the assessment, and providing the patient and/or a healthcare service provider with a recommendation for how to improve the patient's asthma condition. In some embodiments, the method may involve providing a recommendation for how to improve the patient's asthma condition. In various embodiments, providing the recommendation and/or the assessment may involve using one or more modalities such as mobile applications, web-based applications, desktop application, visual display on sensor, visual display on base station, lights on sensor, lights on base station, physical gauge on sensor, physical gauge on base station, audible tone from sensor, audible tone from base station, haptic feedback with carried or worn device, haptic feedback on sensor or base station, email message, phone call, fax, video message, video call, audio recording/voicemail, social media, paper mailing, alerts, through or within an electronic health record, and person-to-person meeting.

The method may also optionally involve determining, with the processor, that a specific monitoring action and/or a specific treatment is advisable for the patient, and alerting the patient, a family member of the patient, and/or a healthcare provider that the specific monitoring action and/or specific treatment is advisable. In some embodiments, the alerting step may be carried out via a wireless transmission to the patient, family member and/or healthcare provider. In some embodiments, the method may also involve determining, with the processor, that an asthma exacerbation in the patient has occurred, and alerting the patient, a family member of the patient, and/or a healthcare provider that the asthma exacerbation has occurred. In some embodiments, the alerting step may be carried out via a wireless transmission to the at least one patient, family member or healthcare provider.

In another aspect, a method for assessing the state of the condition of asthma in a patient may involve: sensing individual patient data using one or more sensors on or near the patient; transmitting the individual patient data to a processor; comparing, with the processor, the individual patient data with at least one of baseline patient data related to the patient or population data related to a patient population comparable to the patient, to provide comparison data; determining, with the processor, that an onset of an exacerbation of the patient's asthma condition has occurred; and informing the patient, a family member of the patient, and/or a healthcare provider, that the onset of the exacerbation has occurred. The individual patient data may be related to at least one physiological parameter of the patient, and at least one of the sensors may be a passive sensor that does not require the patient to apply it or activate it.

In some embodiments, the method may further involve analyzing, by a service provider, the individual data, the comparison data and/or the determination of the onset of the exacerbation, and providing the patient or a healthcare service provider with a recommendation for how to improve the patient's asthma condition. Optionally, the method may also involve providing a recommendation for how to improve the patient's asthma condition.

These and other aspects and embodiments are described in greater detail below, in reference to the attached drawing figures.

### BRIEF DESCRIPTION OF THE DRAWINGS

FIG. 1 is a flow diagram illustrating a method for receiving and processing patient information to provide a personalized report, according to one embodiment;

FIG. 2 is a schematic illustration of a system for receiving and processing patient information to provide a personalized report, according to one embodiment;

FIG. 3 is a flow diagram illustrating part of a method for using various patient information to provide a personalized report and generate a feedback loop, according to one embodiment;

FIG. 4 is a flow diagram illustrating a method aggregating data from sensors and non-sensor sources to enhance outcomes, according to one embodiment;

FIG. 5 is a side view figurative representation of a patient lying on a bed with a below-mattress sensor;

FIG. 6 is a side view figurative representation of a patient lying on a bed with a below-mattress sensor; and

FIG. 7 is a figurative representation of a system for receiving and processing patient information to provide a personalized report, according to one embodiment.

### DETAILED DESCRIPTION

The following description of various embodiments should not be interpreted as limiting the scope of the invention as it is set forth in the claims. Other examples, features, aspects, and advantages may be included in various embodiments, without departing from the scope of the invention. Additionally, some of the descriptions below focus on systems and methods for monitoring asthma. In alternative embodiments, however, the systems and methods described herein may be used (or modified for use) for monitoring any of a number of different disease states, such as but not limited to allergies, chronic obstructive pulmonary disease, diabetes, hypertension, autoimmune disorders, migraine or other neurologic disease, obstructive sleep apnea, cystic fibrosis, arthritis and other rheumatologic conditions, seizure disorders, cardiovascular disease, peripheral vascular disease and/or congestive heart failure. Accordingly, the drawings and descriptions should be regarded as illustrative in nature and not restrictive.

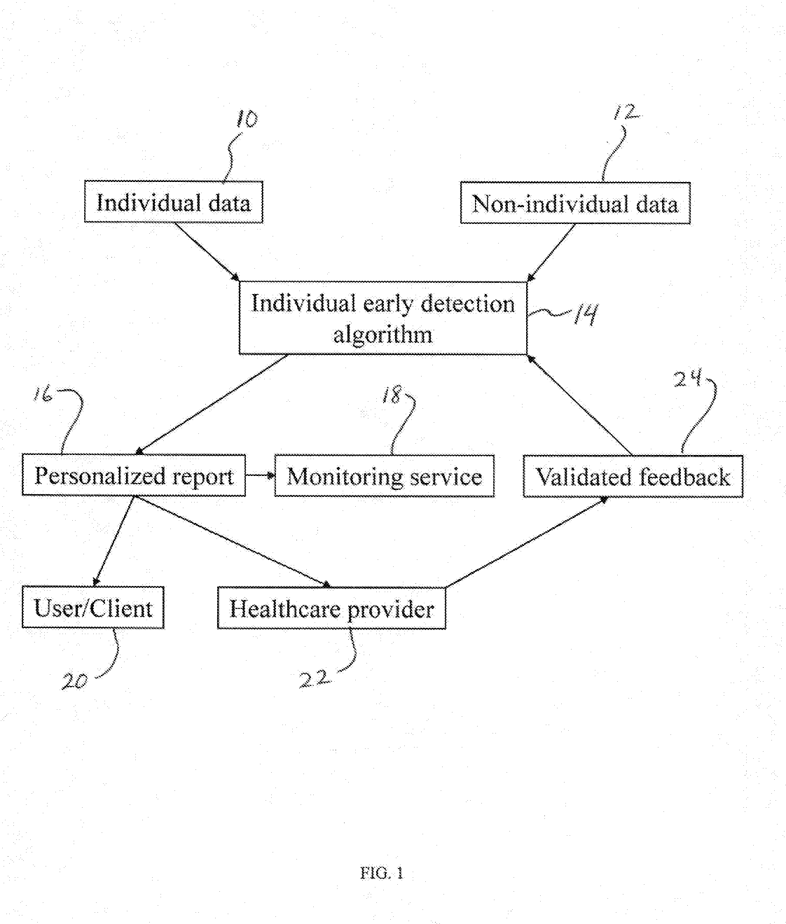

Referring to FIG. 1, a method for monitoring a patient's chronic disease state, according to one embodiment, is illustrated in a flow diagram. This method may be used for monitoring the disease state in one patient or multiple patients, according to various alternative embodiments. In some embodiments, the method may be used for early detection of changes in the disease state. As mentioned previously, asthma is one example of a disease that may be monitored using this method.

As a first step in the method, individual patient data 10 and non-individual patient data 12 are received in a computer processor 14. In alternative embodiments, the processor may receive only individual data 10 or only non-individual data 12. Individual patient data 10 may include, for example, physiological data, past medical, family, and/or surgical history, and/or environmental data pertaining to an environment around or near the patient. A patient monitoring system, which is described further below, may be designed to collect any of a number of different types of individual data 10 from the patient. This individual data 10 may be collected using one or more devices that contact the patient and/or that collect data without contacting the patient (“contactless” devices). Types of individual data 10 that may be collected include, but are not limited to, respiratory rate and/or effort, heart rate and/or variability, oxygen saturation, weight, movement, sleep quality (including number of full or partial awakenings and time of daily final awakening over time), body temperature, exhaled breath composition (including but not limited to carbon dioxide, nitrogen, carbon monoxide), voice pitch and/or other sound-based parameters, air quality, humidity, and/or other environmental data. Examples of non-individual data 12 include, but are not limited to, regional environmental data, such as demographic data and aggregate population data.

After the individual data 10 and non-individual data 12 are received by the processor 14, the data are processed to generate an individual, personalized patient report 16, which may be used to assess status of the patient's disease, such as asthma, hypertension, chronic obstructive pulmonary disease, diabetes, mental health disease, and/or other chronic conditions. This personalized report 16 may be transmitted automatically to a monitoring service 18, to the patient and/or other user 20, and/or to a healthcare provider 22. The healthcare provider 22 (or other user) may then provide validated feedback 24, which may feed back into the processor for further refinement. The processor may generate a patient-specific model, which uses feedback 24 from the health care provider and/or user, regarding symptoms and acute clinical exacerbations to train and improve the model. In this way, the model may be personalized to an individual patient. Using the personalized model, the processor 14 may provide each patient with the personalized report 16 and in some cases multiple reports over time, summarizing the current status of the patient's disease state and/or the status over a period of time. The process of providing feedback to the processor/model, making the model more personalized to an individual patient, and providing another, more personalized report may be repeated as many times as desired for a patient of a course of time. Again, FIG. 1 illustrates only one, exemplary embodiment of the monitoring method. Alternative embodiments may include fewer or additional steps.

In some embodiments of an asthma monitoring method, for example, one or more sensors located under a patient's mattress are used to collect heart rate and respiratory rate individual patient data 10 from the patient (also referred to as “input data”). This individual data 10 is transmitted to the system's processor, which generates a personalized model or uses a pre-existing model. In some embodiments, the processor may reside in the cloud or other remote location. An example of a personalized model is one that analyzes the input data against the patient's baseline data (e.g., normal heart rate and respiratory rate for that patient). The processor, using the model, will generate a personalized report 16, showing the patient's current disease state relative to a normal state for the patient. For example, the report could indicate that the patient's heart rate for the past two nights has been 10% above her baseline heart rate. In some embodiments, the system may be configured to generate any of a number of alerts or recommendations, which may be transmitted to the patient, healthcare provider and/or other user. For example, the system may generate a text alert if the patient's heart rate has been 20% above her baseline heart rate for the past two nights. In some embodiments, the alert may inform the patient (and/or others) as to the patient's disease condition and may also provide a recommendation, such as that the patient should contact his/her healthcare provider for further diagnosis.

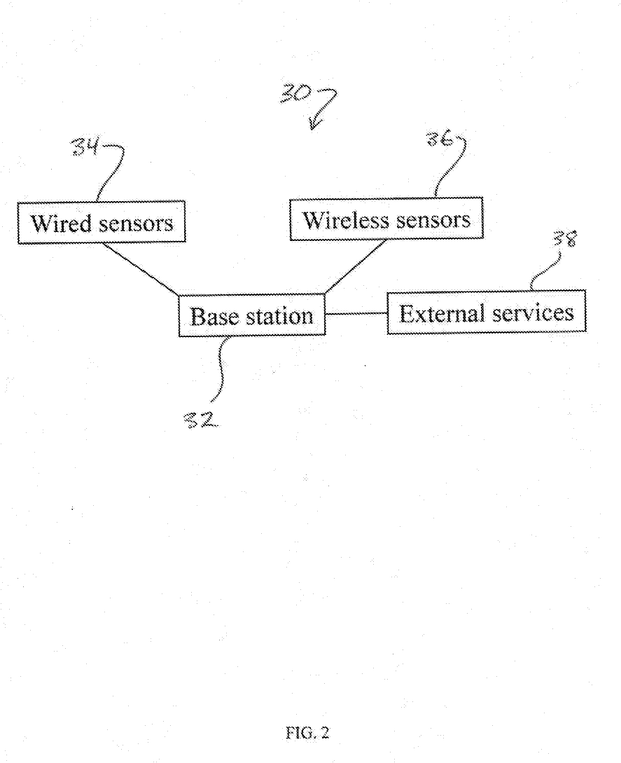

Referring now to FIG. 2, one embodiment of a disease state monitoring system 30 is illustrated, which may be used to generate the individual patient data 10 used in the method described above. In this embodiment, the system 30 includes a base station 32, one or more wired sensors 34, one or more wireless sensors 36 and one or more external services 38. In alternative embodiments, the system 30 may include only wired sensors 34, only wireless sensors 36, only external services 38, any combination thereof, or any other combination of sensors and/or services. The base station 32 may include a local storage mechanism, a processor, and connection means for connecting to a remote server. In alternative embodiments, the base station 32 may not include a processor and may simply act as a receiver of data from one or more sensors or other sources and a transmitter of that data to a separate processor, such as a processor located in the cloud or other remote location. In some embodiments, the base station 32 may also be configured to store sensor data after it is received. In some embodiments, the processor in the base station 32 may also pre-process the received data before transmitting the data to a remote server for further processing. Pre-processing the data may include, but is not limited to, compressing the data, extracting features from the data, and/or generating a local model of the data. The base station 32 can also act as a node in a distributed computing platform, which may be necessary for cost-effective computation of extensive datasets. Raw data can be sent to this node via the remote server or a peer-to-peer network and can then be processed using the computing power of this node.

The sensors 34, 36 may be connected to the base station 32 either through a wired (including electrically connected) or wireless connection, including, but not limited to, RFID, Bluetooth, WiFi, and/or Zigbee. The sensors 34, 36 can be within the base station 32 enclosure or outside the enclosure. The sensors 34, 36 can communicate with the base station 32 either in real-time or transferred at a later time through a wired or wireless connection. The sensors 34, 36 themselves may optionally include a processor and/or local data storage. Such processor and storage could, in some embodiments, serve the functions of the base station 32 and thereby eliminate the need for a separate base station.

One or more external services 38 may also provide data to the base station 32. For example, these services may include sensors connected to home thermostats, smart home sensing systems, or regional meteorological measuring equipment that are able to provide data as external services. Likewise, the base station 32 can also communicate with other external services 38, for example, such as services that can control temperature, humidity, or air purification.

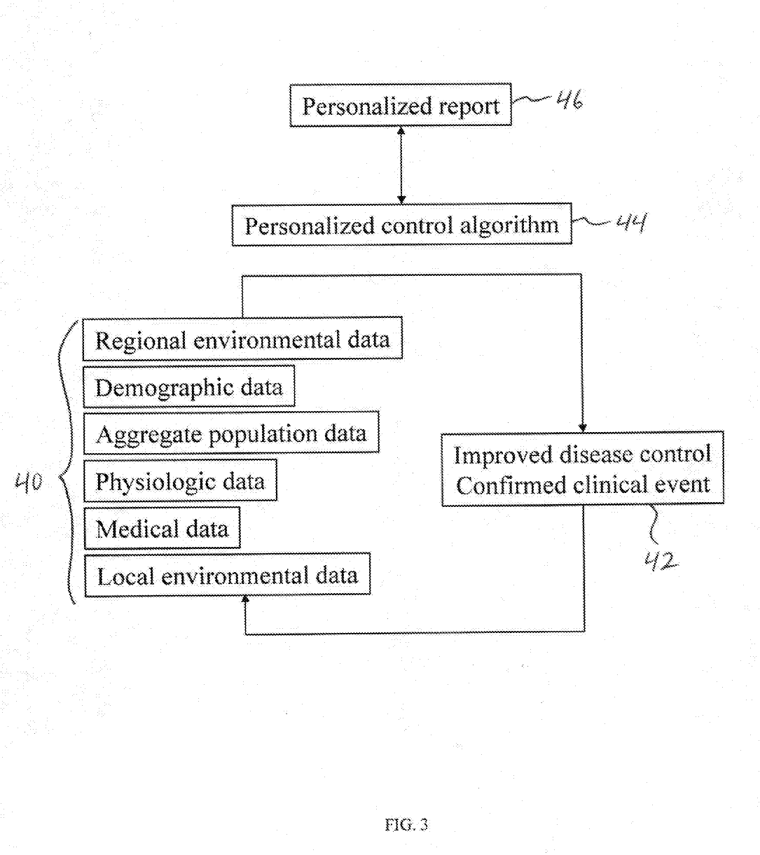

With reference now to FIG. 3, one embodiment of a data flow and analysis is shown in greater detail. In this embodiment, data is received into the system from multiple sources 40, such as but not limited to physiologic data related to the individual or group of individuals, local environmental data from where the individual spends a substantial amount of time (for example, home, work, vehicle), geographic environmental data from sources such as those found available online, and/or clinical symptom data obtained from an individual or group of individuals. The data available from these sources are processed 44 for each individual or group of individuals, and feedback regarding disease state and control is provided, such as in the form of a report 46, to the individual, group of individuals, and/or healthcare provider(s). Improved disease control and confirmed clinical events—worsening of disease state requiring treatment alteration, clinic visit, emergency care or hospitalization—may also be recorded 42 and will be used to improve the personalized algorithm to determine disease control. The system, with or without human interaction, continuously monitors each individual for changes to his/her disease state. If the estimated condition has worsened beyond a calculated level based on individual or population-level historical data analysis, the individual, group of individuals, guardian and/or the healthcare provider may be notified via text messaging, email, phone call, videoconference, personal visit, integration with the electronic medical record, combinations of any of these methods and/or any other suitable methods.

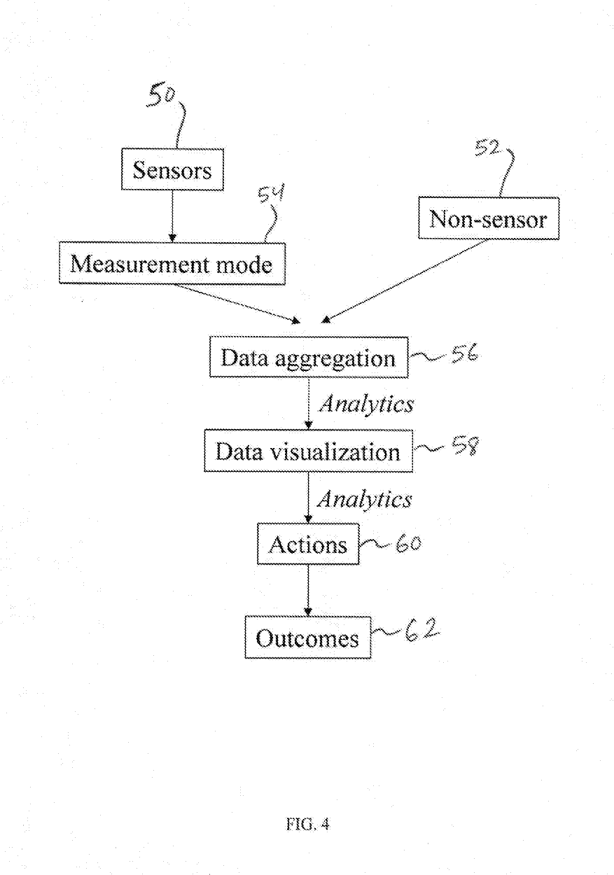

Referring now to FIG. 4 an additional flow chart is provided, to illustrate a method for processing sensor data 50 and non-sensor data 52, according to one embodiment. A measurement mode 54 may be selected for one or more sensors being used. The sensor data 50 and non-sensor data 52 may be aggregated 56, and the aggregated data 56 may be analyzed, and the data may then be displayed in some way, so that the user/patient can visualize the data 58. The data may then be analyzed again to provide one or more recommended actions 60 for the patient (or other user) to follow, which may provide enhanced outcomes 62 for the patient.

This flow chart is intended to describe a multitude of potential non-sensor 52 or sensor 50 systems in the form of wired, wireless, or external services or sensors and anticipated measurement modes 54 that may be collectively analyzed and presented or visualized to produce desired actions 60 and resulting outcomes 62. Sensors 50 may be used in combination or individually to produce single or multiple measurement modes 54. For example, sound or piezoelectric sensors may be used to measure an individual's cough frequency, breath sound analysis, voice analysis, snoring, sniffle and/or crying. The sensors 50 may be incorporated within the base station 32 or may be external to the base station 32, such as an external sensor placed under and/or attached to the individual or group of individuals, mattress, pillow, bed and/or clothing.

In various alternative embodiments, examples of sensors 50 include, but are not limited to, piezocapacitave, piezoresistive, piezometer, barometric, capacitance, current, voltage, resistance or impedance, inductance, elastoresistive, electromagnetic, optical, potentiometric, laser, kinetic inductance, fiber optic, radiofrequency, sonar, opto-acoustic, electro-optical, phototransistor, photodetector, visual light, gyroscopic, stress, strain, bolometer, altimeter, inclinometer, impact, radar, LIDAR, photoelectric, position, rate, calorimetric, ultrasonic, infrared, contact, scintillometric, thermometer, thermistor, pyrometer, image, video, actimeter, accelerometer, gas, spectrometer, opto-chemical, electrochemical, biochemical, olfactory, and time sensors. Measurement modes 54 for the sensors 50 may include, but are not limited to: local atmospheric pressure; regional atmospheric pressure; changes in local atmospheric pressure associated with, but not limited to, geographic location, time, disease status; changes in regional atmospheric pressure associated with, but not limited to, geographic location, time, disease status; differential and changes in temperature between, but not limited to, measurement modes, time, geographic location, disease status; instantaneous and changes in inspiratory and expiratory curves by which effort, work, rate, lung volumes and interactions with cardiac physiology can be determined; frequency, changes, and characterization of cough or sniffle episodes within specified periods of time and interactions with cardiorespiratory physiology; instantaneous and changes in cardiac physiology including estimated venous return, ballistocardiogram, heart rate, function, blood pressure, pulse pressure, and heart rate variability and interactions with respiratory physiology; changes of the relationship between physiologic and pathophysiologic cardiorespiratory conditions associated, but not limited, to geographic location, medication use, time, and disease status; frequency, changes, and characterization of cough episodes within specified periods of time and interactions with cardiorespiratory physiology; relationships between physiologic and pathophysiologic cardiorespiratory conditions; frequency, magnitude, and changes over time of gross body movements; local and regional environmental temperature; global positioning system (GPS) location; exhaled breath temperature; thoracic cavity body temperature; body temperature; local altitude; exhaled breath carbon monoxide, nitric oxide, oxygen, and carbon dioxide; local environmental carbon monoxide, nitric oxide, nitrogen dioxide, oxygen, and carbon dioxide; local and regional air particulate levels; changes in local altitude associated with, but not limited to, geographic location, time, disease status; changes in air particulate levels associated with, but not limited to, geographic location, time, disease status; changes in physical activity levels associated with, but not limited to, cardiorespiratory physiology, geographic location, time, disease status; physical activity levels; satellite images and changes of the regional environment; changes in voice sounds, including, but not limited to pitch, sniffles, and snoring; instantaneous and change in oxygen saturation; sounds in local environment; changes in sounds in local environment; voice sounds; images and change of local environments; changes in sounds emitted during respiratory cycles; sounds emitted during respiratory cycles; local environmental humidity; regional environmental humidity; changes in local environmental humidity; changes in regional environmental humidity; local environmental tobacco smoke; patient body mass and trends; presence or absence of disease-indicative compounds and trends in urine, sputum, blood, or secretions; local and regional levels of disease-aggravating chemicals both airborne and contact; changes in local environmental tobacco smoke; presence or absence of and exposure to dust mites; sleep status, history, and characteristics; levels of or changes in diaphoresis; cardiorespiratory function; changes in cardiorespiratory function; changes in immunologic function or response; and immunologic function or response.

In various alternative embodiments, locations for passive data collection sensors may include bed, mattress, pillow, couch, lamp, bedside table, ceiling, wall, car seat, windshield, doormat, television, television remote control, gaming system, gaming system controls, desktop, desk chair, workstation, computer screen, computer keyboard, computer mouse, tablet computer, mirror, toilet, floor in front of sink, eyeglasses, jewelry, wallet, belt, clothing, watch, watchband, phone, phone screen or interface, toys, toothbrush, steering wheel, purse, handbag, briefcase, shoes, socks, keys, coffee mug, silverware, water bottle, headphones, backpack, security camera, security system, body, skin, hearing aid or other ear appliance, oral appliance, contact lenses, medication delivery device, inhaler or the like. These sensor locations may be used individually or in combination. Data captured by the sensors may either be streamed in real-time or recorded at a point in time. If a base station 32 is being used, it may capture and aggregate raw data from these sensors 50 and store the data locally. Full processing, no processing, or limited pre-processing of sensor data can be performed on the base station 32 or sensor system. In the example of audio data, processing may include but is not limited to extracting relevant features from the audio, for example wheezing, changes in pitch, snoring, shortness of breath, sniffling, and/or the frequency content of the relevant sound. The base station 32 or sensor system can display or stream the complete raw data or a subset of the raw-data and the pre-processed features to a remote server.

In various embodiments, any of a number of different devices and method may be used to display data to a patient or other user for visualization 58. For example, data may be displayed via mobile applications, web-based applications, desktop application, visual display on sensor, visual display on base station, lights on sensor, lights on base station, physical gauge on sensor, physical gauge on base station, audible tone from sensor, audible tone from base station, haptic feedback with carried or worn device, haptic feedback on sensor or base station, email message, phone call, fax, video message, video call, audio recording/voicemail, social media, paper mailing, alerts, through or within an electronic health record, or person-to-person meeting.

The method may next provide one or more recommended actions 60 to a patient, healthcare provider, family member and/or other user(s). Such actions may include, but are not limited to, Various actions may be taken to improve disease control, resulting from the measurements obtained from various sensors and the results of algorithmic analysis and/or review and assessment of the system data by patients, caregivers, healthcare providers, and other persons, may include but are not limited to medication regimen adjustment; early initiation of emergent or rescue medications, for example, albuterol and/or oral steroids; avoidance of regional environmental triggers; tobacco cessation; use of allergen-impermeable pillow and mattress covers; washing bedding; removing old carpet; managing home humidity level; washing stuffed animals weekly; removing pets from the home; keeping pets out of bedrooms; properly sealing and storing food; sealing trash containers; regularly cleaning surfaces and floors; regular pest and insect management; assessment of home environment; development and initiation of home remediation plan; education on local (home) and regional environmental triggers; disease self-management education; disease specific education; improving access to medical care; improving coordination of care; change in diet; change in hygiene habits; change in monitoring methods/intensity; adjustment in schedule or routine; scheduling a visit or visits with healthcare provider(s); connecting patient with social network; regulation of local environment temperature; regulation of local environment humidity; regulation of air particulate; and reporting system individual and population level data. Outcomes 62 resulting from the method may include, but are not limited to, reductions in hospitalization; reduction in emergency department visits; reduction in unscheduled office visits; improvement in disease control; improvement in quality of life; reduction in missed school days for children; reduction in missed work days for adults or caregivers; reduction in caregiver stress; improvement in pulmonary function; improvement in medication or treatment plan adherence; reduction in annual reimbursed healthcare expenditures; reduction in rescue inhaler or emergent medication use; improvement in controller medication use; effective use of therapies, including, for example in asthma, oral corticosteroids, inhaled corticosteroids, anti-viral medications; reduction in annual out-of-pocket healthcare expenditures; reduction in activity limitation; reduction in symptom days; reduction in asthma exacerbations; reduction in disability; aid in healthcare provider reporting requirements; and changes in disease-specific policy considerations.

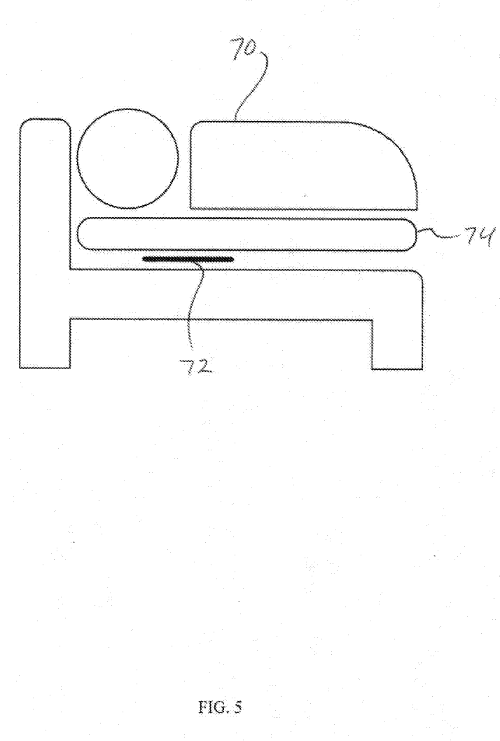

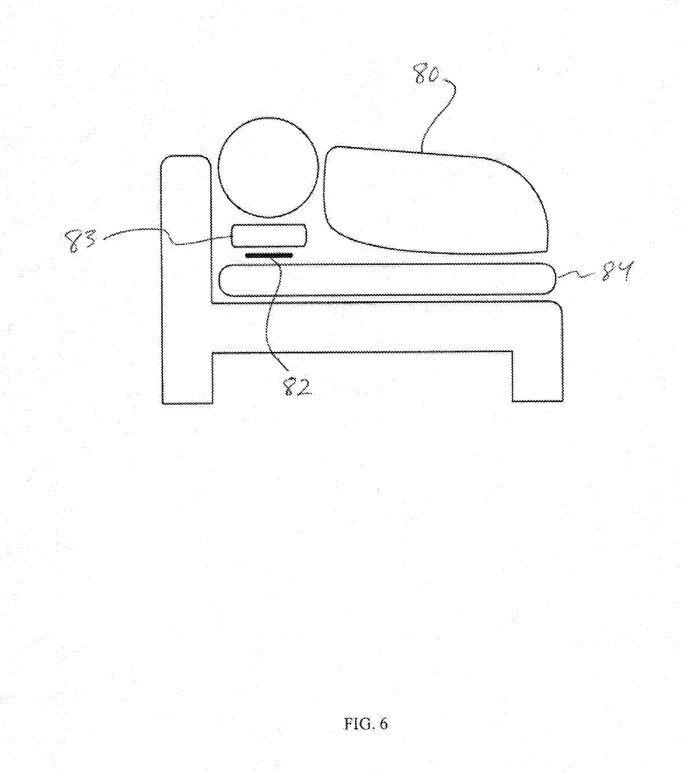

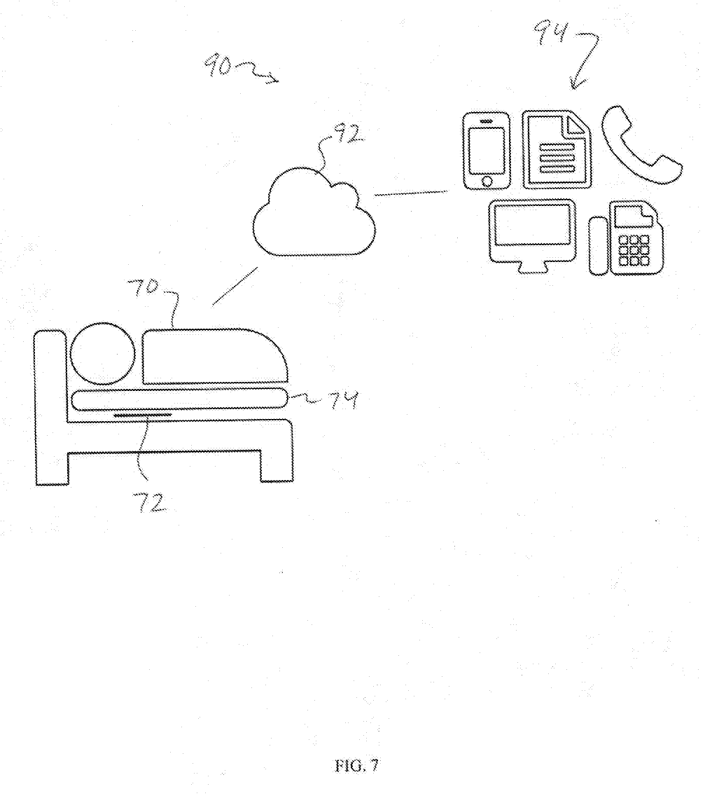

Now referring to FIGS. 5-7, simple illustrations of a system for monitoring asthma in a patient are provided. Referring to FIG. 5, in some embodiments, one or more sensors 72 may be placed under a mattress 74 on which the patient 70 sleeps. In an alternative embodiment, shown in FIG. 6, one or more sensors 82 may be placed under a pillow 83 on which a patient 80 sleeps, rather than under a mattress 84. Of course, sensors 72, 82 could be placed under both a mattress and a pillow, in other embodiments. Any suitable combination of sensor placements may be used. FIG. 7 illustrates one embodiment of a monitoring system 90 as a whole. In this embodiment, system 90 includes at least one sensor, which transmits data either to a local base station (not shown) or directly to the cloud 92 or other remoter storage and analytics server for processing. The data can then be displayed and visualized via any suitable display device 94.

In one embodiment, the remote server can receive and store the data multiple, deployed base station 32. The raw data from each of the deployed base stations 32 can be stored in a file and/or in a database. The remote server can use the sensor data and pre-processed extracted features from each individual or group of individuals and/or external data, including but not limited to, either in combination or separately, weather data, pollen levels, pollution levels, public health records, and other relevant data, to generate a model for each individual or local group of individuals. These models may also be further refined by using aggregate sensor data and pre-processed extracted features collected from all individuals or all groups of individuals. The model may be generated using an algorithm, running on either the server or the base station, which would output data and analysis associated with that individual and their current level of asthma control, including, but not limited to, the frequency of symptoms, the predicted future severity, time period of prediction, and/or confidence level. The algorithm may generate a model for each individual, and that model may be refined on an ongoing basis as the algorithm receives and analyzes more data to more accurately assess the patient's condition. If the individual's present condition and/or predicted future condition passes a pre-defined level (discussed below), the individual, guardian and/or health care provider may be notified either through, for example, text messaging, email, phone call, and/or integration with the electronic medical record. The pre-defined level may be set in a number of ways, including but not limited to, thresholds relative to the patient's baseline statistics, thresholds relative to general population statistics, and/or confidence levels in the personalized model generated by the algorithm.

The healthcare provider and/or individual or group of individuals can directly provide additional information to the system for use in the algorithm. The individual and/or guardian can record daily symptoms and/or other physiologic measurements, such as peak flow test results, as would normally be recorded in an asthma symptom diary. Healthcare providers can confirm and/or input the individual current asthma condition during or following clinic visits, emergency department visit, and/or hospitalization, to train and validate the model. This feedback will not only improve the accuracy of that particular individual's model, but will also improve all other individuals' models. The machine-learning or other statistical algorithm can also use healthcare data captured from, but not limited to, the individual's electronic medical record, billing records, prescription orders, and/or inhaler or other medication use, to further refine the model.

Another possible feature is that the individual and/or group of individuals, guardian and/or the healthcare provider can also monitor the individual's condition through a web page, mobile application, desktop application, and/or accessed through an electronic medical record. Another possible feature is that the system may deliver information, including but not limited to recommendations and/or alerts, to the individual (or the individual's guardian or health care provider) to a mobile or other handheld device.

Archiving the data can be performed locally at the base station or sensor, or on the remote server. The system will make the data available to users and/or healthcare providers in pre-defined formats, and the users can request access to the data, specifying, but not limited to, which data, time-range, and/or feature. The remote server may then forward that request to the individual base station 32 or present the data stored on the remote server. In the event that the data is being stored locally, it will be locally processed to satisfy the query, and will return the data to the server, where it then subsequently gets displayed to the requestor. This distributed architecture may reduce the storage requirement and may partially reduce the computing resources needed for the remote server, which may subsequently reduce power requirements for system operation.

In some embodiments, the individual data may be configured to differentiate between multiple individuals sleeping in the same bed and for example be able to differentiate between sounds, physiologic parameters, and/or motion from different individuals. Algorithms, including beam forming, may be required to differentiate data sources and produce more reliable, robust, and/or accurate individualized data. Another embodiment is having sensors designed to capture data for each individual.

One example of the above embodiment would be using two or more sensors placed apart from each other—for example at least two sensors that passively detect the heart rate and respiratory rate of individuals who are sleeping on a bed or who are in a room. The following example can also be implemented using sensors placed in various locations acting in a multitude of measurement modes, as described above. Using a machine-learning algorithm that may include, for example, support vector machine and neural networks, the machine can identify the contribution of each individual to the sensor input. This allows the system to have a clean input of the sensor data that is not confounded by other individuals, allowing for easier subsequent processing. This concept may be useful, for example, in identifying the heart rate and respiratory rate of multiple individuals sleeping on the same bed or in the same room. In this example, two or more piezoelectric crystals are placed under the bed in opposite corners. The piezoelectric crystals may be mechanically split into quadrants, where the deflection of each quadrant is monitored by sampling its voltage. This allows monitoring for absolute position of the movement in the three dimensions, X-Y-Z. The sampling rate of both piezoelectric crystal sensors is at a sufficient speed such that the delta time difference for a movement to travel different distances to reach both sensors can be captured. When an individual breathes, this causes a deflection of the sensor, which changes in a repeatable pattern in the 3D space. This is also true when the individual heart beats, causing a smaller deflection of the sensor, and also changes in another repeatable pattern in the 3D space. The system would first isolate the aggregate movement of both the movement from the heart beating and also the movement from breathing contributed by each individual as described above. The system would then isolate the movement contributed from the heart beating and the lungs inflating for each individual, using machine learning, including but not limited to support vector machine and neural networks. Once the movement associated with the heart beating and the movement associated with breathing can be extracted for each individual, analysis for individual heart rate and respiratory rate can then be performed. Each of the isolated signals would then be further processed using digital signal techniques and/or artificial learning, and the individual heart rate and respiratory rate can be decoded.

The base station 32 may have accessory features, such as a clock, alarm clock, night-light, and/or music playing capability. This base station 32 could be on a bedside table, attached to the bed, on the wall, ceiling or anywhere else in the room where the individual or group of individuals will be monitored or in any other suitable location, such that the relevant data can be transmitted to and from the base station 32.

There are certain technical challenges in representing and delivering personalized models and monitoring capabilities. The amount of data required to capture and analyze is significant and computationally intensive. A model can be designed for the individual user; however, it would also be beneficial for the system to capture a population level dataset to build a more robust model and provide additional business and clinical value, such as for use in the development of medications and/or population health interventions. The collection and analysis of this dataset may be conducted, for example, through the base station 32 as a node in a distributed computing network. This distributed computing network is envisioned to provide analytics for other external services not specific to the current intended application, and more specifically, for early detection of asthma exacerbation. Each node will feature local storage and be configured to perform computing. The remote server will act as the master and can pull pre-processed data from the individual nodes to generate a population-based model. This is discussed in additional detail above.

Although specific embodiments of the disclosure have been described herein for purposes of illustration, various modifications may be made without deviating from the spirit and scope of the disclosure. For example, although the present application includes several examples of monitoring fluid changes in the human brain as one potential application for the systems and methods described herein, the present disclosure finds broad application in a host of other applications, including monitoring fluid changes in other areas of the human body (e.g., arms, legs, lungs, etc.), in monitoring fluid changes in other animals (e.g., sheep, pigs, cows, etc.), and in other medical diagnostic settings. Fluid changes in an arm, for example, may be detected by having an arm wrapped in a bandage that includes a transmitter and a receiver. Accordingly, the scope of the claims is not limited to the specific examples given herein.

We claim:

1. A method for assessing the state of the condition of asthma in a patient, the method comprising:
sensing individual patient data using one or more sensors on or near the patient, wherein the individual patient data is related to at least one physiological parameter of the patient, and wherein at least one of the sensors comprises a passive sensor that does not require the patient to apply it or activate it;
transmitting the individual patient data to a processor;
comparing, with the processor, the individual patient data with at least one of baseline patient data related to the patient or population data related to a patient population comparable to the patient, to provide comparison data; and
providing an assessment of the current state of the patient's asthma condition, based on the comparison data.

2. The method of claim 1, further comprising:
analyzing, by a service provider, at least one of the individual data, the comparison data or the assessment; and
providing at least one of the patient or a healthcare service provider with a recommendation for how to improve the patient's asthma condition.

3. The method of claim 1, further comprising providing a recommendation for how to improve the patient's asthma condition.

4. The method of claim 3, wherein providing the recommendation comprises using a modality selected from the group consisting of mobile applications, web-based applications, desktop application, visual display on sensor, visual display on base station, lights on sensor, lights on base station, physical gauge on sensor, physical gauge on base station, audible tone from sensor, audible tone from base station, haptic feedback with carried or worn device, haptic feedback on sensor or base station, email message, phone call, fax, video message, video call, audio recording/voicemail, social media, paper mailing, alerts, through or within an electronic health record, and person-to-person meeting.

5. The method of claim 1, wherein providing the assessment comprises using a modality selected from the group consisting of mobile applications, web-based applications, desktop application, visual display on sensor, visual display on base station, lights on sensor, lights on base station, physical gauge on sensor, physical gauge on base station, audible tone from sensor, audible tone from base station, haptic feedback with carried or worn device, haptic feedback on sensor or base station, email message, phone call, fax, video message, video call, audio recording/voicemail, social media, paper mailing, alerts, through or within an electronic health record, and person-to-person meeting.

6. The method of claim 1, further comprising:
determining, with the processor, that at least one of a specific monitoring action or a specific treatment is advisable for the patient; and
alerting at least one of the patient, a family member of the patient, or a healthcare provider that the specific monitoring action or specific treatment is advisable.

7. The method of claim 6, wherein the alerting step is carried out via a wireless transmission to the at least one patient, family member or healthcare provider.

8. The method of claim 1, further comprising:
determining, with the processor, that an asthma exacerbation in the patient has occurred; and
alerting at least one of the patient, a family member of the patient, or a healthcare provider that the asthma exacerbation has occurred.

9. The method of claim 8, wherein the alerting step is carried out via a wireless transmission to the at least one patient, family member or healthcare provider.

10. A method for assessing the state of the condition of asthma in a patient, the method comprising:
sensing individual patient data using one or more sensors on or near the patient, wherein the individual patient data is related to at least one physiological parameter of the patient, and wherein at least one of the sensors comprises a passive sensor that does not require the patient to apply it or activate it;
transmitting the individual patient data to a processor;
comparing, with the processor, the individual patient data with at least one of baseline patient data related to the patient or population data related to a patient population comparable to the patient, to provide comparison data;
determining, with the processor, that an onset of an exacerbation of the patient's asthma condition has occurred; and
informing at least one of the patient, a family member of the patient, or a healthcare provider, that the onset of the exacerbation has occurred.

11. The method of claim 1, further comprising:
analyzing, by a service provider, at least one of the individual data, the comparison data or the determination of the onset of the exacerbation; and
providing at least one of the patient or a healthcare service provider with a recommendation for how to improve the patient's asthma condition.

12. The method of claim 1, further comprising providing a recommendation for how to improve the patient's asthma condition.
